(19) United States
(12) Patent Application Publication
(10) Pub. No.: US 2021/0141836 A1
(43) Pub. Date: May 13, 2021

(54) HARD DISK AND IN-MEMORY DATABASE OPERATIONS

(71) Applicant: FinancialForce.com, Inc., San Francisco, CA (US)

(72) Inventor: Matthew James Byrne, Harrogate (GB)

(21) Appl. No.: 16/681,502

(22) Filed: Nov. 12, 2019

(51) Int. Cl. G06F 16/9038; G06F 16/9035; G06F 16/25

(52) U.S. Cl. CPC G06F 16/9038; G06F 16/252; G06F 16/9035

(57) ABSTRACT

Disclosed herein is a computational scheme wherein derived calculations of records contained in a disk drive are replicated in-memory and performed in the memory. database records that are generally stored in the hard drive and are temporarily replicated exactly in-memory which takes advantage of a significantly faster read/write time than the disk drive to compute derived resolutions to ad hoc queries. Ad hoc queries include a number of parameters which enable an arbitrarily large number of permutations of query type.

### TECHNICAL FIELD

The disclosure relates to in-memory databases and more particularly to manipulations of data in different storage environments.

### BACKGROUND

Manipulation of data stored on a hard disk is slow when compared to manipulation of data in volatile memory. However, storing data in volatile memory is risky. In-memory databases need to consistently maintain power in order to store persistent data. Additionally, volatile memory is more expensive than hard disk (including solid state) storage.

### BRIEF DESCRIPTION OF THE DRAWINGS

FIG. 1 is a flowchart illustrating a method of performing calculations of hard-disk stored data in volatile memory.

FIG. 2 is a block diagram of a semi-in-memory database.

FIG. 3 is a screenshot of a resolution to database query resolved in-memory.

FIG. 4 is a screenshot of an underlying transactions within a query resolution.

FIG. 5 is a block diagram of a computer operable to implement the disclosed technology according to some embodiments of the present disclosure.

### DETAILED DESCRIPTION

Disclosed herein is a semi-in-memory database data manipulation technique. Performing numerous calculations into and out of hard disk (including solid state drive, “SSD”) storage is prohibitively slow when compared to data manipulation performed in volatile memory. Calculations that require many hours when performed in hard-disk storage may require only a fraction of a second when performed in volatile memory. Conversely, maintaining persistent data in-memory is expensive and risks data loss.

One way of reducing calculations performed in hard disk storage is to merely store all derivable data from a dataset, or limit queries of the database to stored data only. This way no calculations need be performed in hard-disk storage. Only retrieval operations need be performed. However, there are significant downsides of this approach. First, storing all derivable data dramatically increases the storage space required for any given dataset. Limiting queries to those that may be answered with retrieval operations reduces the functionality of the database system.

For example, a database that fields queries regarding account balances as of queried dates cannot feasibly store all derivable data from a given set of account statements. The potential queries regarding various account statements as of every possible arbitrarily determined date cannot be feasibly be stored in hard disk space. There are too many permutations of query that could be requested. Therefore, the database needs to perform calculations to derive the resolution to queries.

FIG. 1 is a flowchart illustrating a method of performing calculations of hard-disk stored data in volatile memory. In step 102, a set of records are stored in a hard drive storage. Examples of hard drive storage include traditional hard disk drives (HDD) that make use of magnetic disks and a flying head, or solid-state disk drives (SSD). Examples of records include as of accounts records. As of accounts records reference an entity, an amount (e.g., accounts receivable for the entity) and a date relevant to that amount (e.g., an invoice date). The example of an as of accounts record is merely illustrative, and the method may be implemented using other types of records.

In step 104, the records are replicated in volatile memory. The volatile memory may be situated architecturally in the same machine as the hard drive, in another machine, or accessible through the Internet. A processor performs a retrieval operation on relevant portions of the hard drive and the retrieved data is replicated in volatile memory.

In some embodiments, the timing and scope of the replicated records varies. The timing may vary based on user interaction. In some embodiments, the replication of records is automatic based on receipt of a query on the database from a user. In another embodiment, the replication of records is triggered automatically based on a user imitating use of a database management application (e.g., an application configured to generate queries of the database).

Examples of variations of scope relate to which records are retrieved and replicated. In some embodiments, the records retrieved only pertain to entities included in the query, or records that are within a date range relevant to the query. By limiting the scope of the records replicated in volatile memory, the system expense on memory is reduced. Filtering retrieved records does call for operations in the hard drive, though these operations may be limited based on storage organization techniques such as filling the hard drive in predictable ways based on generation of new records. Where new records are created monthly (e.g., invoices), the hard drive may be allocated by entity, time, or other stored data metrics.

In step 106, the system performs calculations based on the query on the records in-memory. The calculations derive a resolution to the query from the records in-memory. The resolution includes whatever information the user was seeking in the query. For example, if the query is how much did X owe 90 days ago, the calculations add all invoices and payments for X until 90 days prior to the query. Multiple calculations may be performed efficiently in volatile memory using dynamic programming.

In step 108, the resolution to the query is output onto the user's graphic user interface (GUI). In step 110, the records that have been replicated into memory remain in-memory until the user has indicated that no more queries of the records will be made. The user indication may come from closing the database management application, or by navigating away from the GUI that enables queries of the database.

FIG. 2 is a block diagram of a system of semi-in-memory database management 20. The system 20 includes a hard drive 22 storing records 24. The hard drive 22 communicates with an application backend server 26 that manages processor calls to the hard drive 22 and volatile memory 28. In some embodiments the hard drive 22, the application backend server 26 and the volatile memory 28 are all on the same machine. In other embodiments, the hard drive 22, the application backend server 26, and the volatile memory 28 are spread across multiple machines.

The application backend server 26 communicates with an application front end 30. The application front end 30 includes a graphic user interface 32. The graphic user interface 32 receives queries from users. The queries are forwarded to the application backend server 26. The application backend server 26 retrieves the records 24 from the hard drive 22 and replicates the records 24 in the volatile memory 28. Operations or calculations used to derive a resolution to the query are performed on the records 24 in the volatile memory 28. The volatile memory 28 has a significantly faster read/write speed than the hard drive 22. In some architectures, the volatile memory 28 is physically closer to a processor of the application backend server 26 than to the hard drive 22.

FIG. 3 is a screenshot of a resolution to database query resolved in-memory. The resolution 34 is displayed on the GUI 32. In a given example of a resolution 32, account values are given as of a specific date (e.g., Apr. 3, 2019). Entities 36 are displayed down the leftmost column, and account values are distributed into buckets (e.g., 30-day increments) 38. None of the numerical data exists within the hard drive 22, each cell of the resolution to the query 34 is calculated in-memory based on underlying data records 24. Because the calculations are performed in-memory the query resolution can feasibly be requested on an ad hoc basis and use arbitrary parameters. In prior art systems, limited queries, based on predetermined query parameters, are calculated from the hard drive on a monthly basis. The time required to perform calculations is hidden (e.g., not apparent to a user) in the lengthy (e.g., monthly or weekly) periodic update time.

The GUI 32 includes a query configuration 40 where a user may select parameters from which to define a query.

FIG. 4 is a screenshot of an underlying transactions 42 within a query resolution. The underlying transactions 42 illustrate data included within the hard drive records 24 (and replicated to the memory), and how that data is applied to a query resolution 34. The data records 24 from the hard drive that are depicted include document numbers, lines within those documents, the dates of the documents (or sub-dates within the document) and amounts associated with particular portions of the documents. Based off other documents (uncited), an amount remaining of the documented amount 44 is calculated as of the queried date. The last column depicted 46 is calculated from the query date compared to the document/line dates. The as of value 44 is calculated by comparing receipts with invoices as of the queried date. In some cases, a given as of value 48 is less than a given documented value 50 because an invoice has been partially paid.

Based on the underlying transactions 42, an arbitrarily large number of unique queries can be generated from combinations of parameters. The system may field any number of queries in quick succession, based on any combination of parameters.

FIG. 5 is a block diagram of a computer 500 operable to implement the disclosed technology according to some embodiments of the present disclosure. The computer 500 may be a generic computer or specifically designed to carry out features of the disclosed user input conversion system. For example, the computer 500 may be a system-on-chip (SOC), a single-board computer (SBC) system, a desktop or laptop computer, a kiosk, a mainframe, a mesh of computer systems, a handheld mobile device, or combinations thereof.

The computer 500 may be a standalone device or part of a distributed system that spans multiple networks, locations, machines, or combinations thereof. In some embodiments, the computer 500 operates as a server computer or a client device in a client-server network environment, or as a peer machine in a peer-to-peer system. In some embodiments, the computer 500 may perform one or more steps of the disclosed embodiments in real time, near real time, offline, by batch processing, or combinations thereof.

As shown in FIG. 5, the computer 500 includes a bus 502 that is operable to transfer data between hardware components. These components include a control 504 (e.g., processing system), a network interface 506, an input/output (I/O) system 508, and a clock system 510. The computer 500 may include other components that are not shown nor further discussed for the sake of brevity. One who has ordinary skill in the art will understand elements of hardware and software that are included but not shown in FIG. 5.

The control 504 includes one or more processors 512 (e.g., central processing units (CPUs)), application-specific integrated circuits (ASICs), and/or field-programmable gate arrays (FPGAs), and memory 514 (which may include software 516). For example, the memory 514 may include volatile memory, such as random-access memory (RAM), and/or non-volatile memory, such as read-only memory (ROM). The memory 514 can be local, remote, or distributed.

A software program (e.g., software 516), when referred to as “implemented in a computer-readable storage medium,” includes computer-readable instructions stored in the memory (e.g., memory 514). A processor (e.g., processor 512) is “configured to execute a software program” when at least one value associated with the software program is stored in a register that is readable by the processor. In some embodiments, routines executed to implement the disclosed embodiments may be implemented as part of an operating system (OS) software (e.g., Microsoft Windows® and Linux®) or a specific software application, component, program, object, module, or sequence of instructions referred to as “computer programs.”

As such, the computer programs typically comprise one or more instructions set at various times in various memory devices of a computer (e.g., computer 500), which, when read and executed by at least one processor (e.g., processor 512), will cause the computer to perform operations to execute features involving the various aspects of the disclosed embodiments. In some embodiments, a carrier containing the aforementioned computer program product is provided. The carrier is one of an electronic signal, an optical signal, a radio signal, or a non-transitory computer-readable storage medium (e.g., memory 514).

The network interface 506 may include a modem or other interfaces (not shown) for coupling the computer 500 to other computers over the network 524. The I/O system 508 may operate to control various I/O devices, including peripheral devices, such as a display system 518 (e.g., a monitor or touch-sensitive display) and one or more input devices 520 (e.g., a keyboard and/or pointing device). Other I/O devices 522 may include, for example, a disk drive, printer, scanner, or the like. Lastly, the clock system 510 controls a timer for use by the disclosed embodiments.

Operation of a memory device (e.g., memory 514), such as a change in state from a binary one (1) to a binary zero (0) (or vice versa) may comprise a visually perceptible physical change or transformation. The transformation may comprise a physical transformation of an article to a different state or thing. For example, a change in state may involve accumulation and storage of charge or a release of stored charge. Likewise, a change of state may comprise a physical change or transformation in magnetic orientation or a physical change or transformation in molecular structure, such as a change from crystalline to amorphous or vice versa.

Aspects of the disclosed embodiments may be described in terms of algorithms and symbolic representations of operations on data bits stored in memory. These algorithmic descriptions and symbolic representations generally include a sequence of operations leading to a desired result. The operations require physical manipulations of physical quantities. Usually, though not necessarily, these quantities take the form of electric or magnetic signals that are capable of being stored, transferred, combined, compared, and otherwise manipulated. Customarily, and for convenience, these signals are referred to as bits, values, elements, symbols, characters, terms, numbers, or the like. These and similar terms are associated with physical quantities and are merely convenient labels applied to these quantities.

While embodiments have been described in the context of fully functioning computers, those skilled in the art will appreciate that the various embodiments are capable of being distributed as a program product in a variety of forms and that the disclosure applies equally, regardless of the particular type of machine or computer-readable media used to actually effect the embodiments.

While the disclosure has been described in terms of several embodiments, those skilled in the art will recognize that the disclosure is not limited to the embodiments described herein and can be practiced with modifications and alterations within the spirit and scope of the invention. Those skilled in the art will also recognize improvements to the embodiments of the present disclosure. All such improvements are considered within the scope of the concepts disclosed herein. Thus, the description is to be regarded as illustrative instead of limiting.

From the foregoing, it will be appreciated that specific embodiments of the invention have been described herein for purposes of illustration, but that various modifications may be made without deviating from the scope of the invention. Accordingly, the invention is not limited except as by the appended claims.

1. A method of operating a semi-in-memory database comprising:
storing a plurality of records in a hard drive database, wherein the plurality of records each refer to an entity of a plurality of entities and an amount as of a date;
replicating the plurality of records in the hard drive database in a volatile memory;
receiving a first query from a user including a subset of entities of the plurality of entities and a first date;
performing calculations in the volatile memory that resolve the first query based on the plurality of records in the volatile memory, wherein a resolution to the first query includes a first amount for each of the subset of entities as of the first date; and
outputting the resolution to the first query on a user interface.

2. The method of claim 1, further comprising:
storing the plurality of records in the volatile memory until receiving an indication that the user has existed the user interface.

3. The method of claim 1, further comprising:
storing the plurality of records in the volatile memory until receiving an indication that the user requires no further calculations.

4. The method of claim 1, wherein said replicating is performed automatically in response to:
initiating a database management client application.

5. The method of claim 1, wherein said replicating is performed automatically in response to said receiving the first query.

6. The method of claim 1, wherein the resolution to the first query further includes:
deriving extrapolated data from the plurality of records in the volatile memory, the extrapolated data is not included in the hard drive database.

7. The method of claim 1, further comprising:
receiving a second query from a user including:
the subset of entities of the plurality of entities;
a first range of time; and
a second time range;
performing calculations in the volatile memory that resolve the second query based on the plurality of records in the volatile memory, wherein a resolution to the second query includes a second amount for each of the subset of entities as pertaining to the first time range and a third amount for each of the subset of entities as pertaining to the second time range; and
outputting the resolution to the second query on a user interface.

8. The method of claim 1, wherein the plurality of records that are stored in the hard drive and replicated in the volatile memory are a subset of a larger database of records stored in the hard drive, the method further comprising:
filtering the plurality of records from the larger database of records based on a parameter of the first query.

9. A system of operating a semi-in-memory database comprising:
a hard drive that stores a plurality of records in a database, wherein the plurality of records each refer to an entity of a plurality of entities and an amount as of a date;
a volatile memory that includes replicated copies of the plurality of records;
a user interface including a graphic user interface configured to receive a first query from a user including a subset of entities of the plurality of entities and a first date, the graphic user interface further configured to display a resolution to the first query; and
a processor configured to perform calculations in the volatile memory, the calculations resolve the first query based on the plurality of records in the volatile memory, wherein the resolution to the first query includes a first amount for each of the subset of entities as of the first date.

10. The system of claim 9, wherein the volatile memory is further configured to store the plurality of records until receiving an indication that the user has existed the user interface.

11. The system of claim 9, wherein the volatile memory is further configured to store the plurality of records until receiving an indication that the user requires no further calculations.

12. The system of claim 9, wherein replication of the plurality of records in the volatile memory is performed automatically in response to an initiation of a database management client application.

13. The system of claim 9, wherein replication of the plurality of records in the volatile memory is performed automatically in response to receipt of the first query.

14. The system of claim 9, wherein the resolution to the first query further includes a derivation of extrapolated data from the plurality of records in the volatile memory, the extrapolated data is not included in the hard drive database.

15. The system of claim 9, wherein the user interface is further configured to receive a second query from a user and the graphic user interface is further configured to display the resolution to the second query, the second query including:
the subset of entities of the plurality of entities;
a first range of time; and
a second time range; and
wherein the processor is further configured to perform calculations in the volatile memory that resolve the second query based on the plurality of records in the volatile memory, wherein the resolution to the second query includes a second amount for each of the subset of entities as pertaining to the first time range and a third amount for each of the subset of entities as pertaining to the second time range.

16. The system of claim 9, wherein the plurality of records that are stored in the hard drive and replicated in the volatile memory are a subset of a larger database of records stored in the hard drive, wherein the processor is further configured to filter the plurality of records from the larger database of records based on a parameter of the first query.

17. A method comprising:
in response to a first query including ad hoc parameters, loading a set of records from a hard drive into volatile memory;
deriving, in the volatile memory, a resolution to the first query based on the set of records, wherein said resolution is not included in the hard drive; and
retaining the set of records in the volatile memory for a query receiving period.

18. The method of claim 17, further comprising:
receiving a second query from a user including a second set of ad hoc parameters;
deriving, in the volatile memory, a resolution to the second query based on the set of records, wherein said resolution to the second query is not included in the hard drive; and
clearing the volatile memory of the set of records in response to a user closing a database management application.

19. The method of claim 17, wherein the first query identifies an entity, an as of date, and a plurality of temporal categories.

20. The method of claim 19, wherein the resolution includes an amount for the entity based on the as of date associated with each of the plurality of temporal categories.
